(19) United States
(12) Patent Application Publication
(10) Pub. No.: US 2025/0075554 A1
(43) Pub. Date: Mar. 6, 2025

(54) CONTROL DEVICE AND VEHICLE

(71) Applicant: TOYOTA JIDOSHA KABUSHIKI KAISHA, Toyota-shi (JP)

(72) Inventor: Yuma HIROTSU, Nisshin-shi (JP)

(73) Assignee: TOYOTA JIDOSHA KABUSHIKI KAISHA, Toyota-shi (JP)

(21) Appl. No.: 18/740,532

(22) Filed: Jun. 12, 2024

(30) Foreign Application Priority Data
Sep. 4, 2023 (JP) 2023-143198

(51) Int. Cl. E05F 15/70

(52) U.S. Cl. CPC E05F 15/70; E05Y 2400/446; E05Y 2900/546

(57) ABSTRACT

The control device is mounted on a vehicle having a remotely controllable tailgate. The control unit of the control device executes the opening control of the tailgate when a predetermined condition is satisfied when the opening control command of the tailgate is received from the external device. The predetermined condition includes that the driving of the power source of the vehicle is stopped and the inclination angle in the front-rear direction with respect to the horizontal plane of the vehicle is equal to or less than the predetermined angle.

### CROSS-REFERENCE TO RELATED APPLICATION

This application claims priority to Japanese Patent Application No. 2023-143198 filed on Sep. 4, 2023 incorporated herein by reference in its entirety.

### BACKGROUND

### 1. Technical Field

The present disclosure relates to remote control of a tailgate of a vehicle.

### 2. Description of Related Art

Japanese Unexamined Patent Application Publication No. 2021-082969 (JP 2021-082969 A) discloses a system for remotely controlling operations of an object of control in a vehicle by a portable device operated by a user. In the system disclosed in JP 2021-082969 A, when a state of the portable device transitions to a predetermined operation state in which operations by the user are restricted, during the object of control being operated by remote control, stopping processing for stopping the object of control is executed. JP 2021-082969 A also describes that the object of control includes a tailgate of the vehicle.

### SUMMARY

An object of the present disclosure is to improve safety with respect to remote control of a tailgate of a vehicle.

A control device according to a first aspect of the present disclosure is a control device that is installed in a vehicle equipped with a tailgate that is remotely controllable, the control device including
a control unit for executing opening control of the tailgate, when a predetermined condition is satisfied when an opening control command of the tailgate is received from an external device.

The predetermined condition includes that driving of a motive power source of the vehicle is stopped, and also that an inclination angle in a front-rear direction with respect to a horizontal plane of the vehicle is no greater than a predetermined angle.

A vehicle according to a second aspect of the present disclosure includes the control device according to the first aspect of the present disclosure.

According to the present disclosure, safety related to remote control of a tailgate of a vehicle can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a flow of information in a remote control system according to an embodiment;

FIG. 2 is a block diagram for describing a hardware configuration of a control device and various devices mounted on a vehicle according to the embodiment;

FIG. 3 is a diagram illustrating a state of a vehicle stopped on an inclined surface;

FIG. 4 is a flow of information processing related to opening control of a tailgate by remote control according to the embodiment;

FIG. 5 is a block-diagram for describing a hardware configuration of a control device and various devices mounted on vehicles according to a modification of the embodiment; and

FIG. 6 is a flow of information processing related to opening control of a tailgate by remote control according to a modification of the embodiment.

### DETAILED DESCRIPTION OF EMBODIMENTS

In recent years, a technique for remotely controlling a target vehicle from a place away from the target vehicle has been developed. As the remote control, the opening and closing control of the tailgate of the vehicle can be exemplified. When the tailgate of the vehicle can be opened and closed by remote control, even when the user of the vehicle is located at a place away from the vehicle, the user can use the vehicle as a storage place for the baggage or the like. However, since the tailgate is opened by an operation by a user who is located at a place away from the vehicle, it is a problem to ensure safety in the vehicle and its surroundings. The present disclosure has been made in view of such problems.

A control device according to a first aspect of the present disclosure is a device mounted on a vehicle having a remotely controllable tailgate. When the tailgate of the vehicle is opened by remote control, the control device receives an opening control command of the tailgate transmitted from the external device. Here, the external device is a device installed outside the vehicle and capable of communicating with the vehicle via a network. For example, the external device receives a remote control execution instruction transmitted from a user terminal operated by a user of the vehicle. Further, the external device that has received the instruction to execute the remote control transmits a control instruction for executing the instructed remote control to the control device of the vehicle.

Then, the control unit of the control device executes the opening control of the tailgate when the opening control command of the tailgate is received from the external device. At this time, the control unit executes the opening control of the tailgate when a predetermined condition related to the vehicle is satisfied. That is, if the predetermined condition is not satisfied, the control unit does not execute the opening control of the tailgate even if the opening control command of the tailgate is received.

Here, the predetermined condition includes that the driving of the power source of the vehicle is stopped and the inclination angle in the front-rear direction with respect to the horizontal plane of the vehicle is equal to or less than the predetermined angle. The power source of the vehicle is, for example, an internal combustion engine or a motor. In a state in which the driving of the power source of the vehicle is stopped, the vehicle is stopped. Further, the inclination angle of the vehicle in the front-rear direction with respect to the horizontal plane varies according to the situation of the ground or the like on which the vehicle is stopped. That is, when the vehicle is stopped on an inclined surface, the vehicle is also inclined.

According to the present disclosure, it is possible to suppress the tailgate from being opened by remote control when the vehicle is moving. Further, when the tailgate is opened while the vehicle is stopped in a state where the vehicle is greatly inclined in the front-rear direction, there is a possibility that the luggage placed in the vehicle falls outside the vehicle. On the other hand, according to the present disclosure, it is possible to suppress the tailgate from being opened by remote control in a state where the vehicle is greatly inclined in the front-rear direction. As a result, it is possible to suppress the luggage placed in the vehicle from falling outside the vehicle when the tailgate is opened. Therefore, according to the present disclosure, it is possible to improve safety related to remote control of a tailgate of a vehicle.

Hereinafter, embodiments of the present disclosure will be described below with reference to the drawings. Unless otherwise specified, dimensions, materials, shapes, relative arrangements, and the like of components described in the present embodiments are not intended to limit the technical scope of the present disclosure to those alone.

### Embodiment

### System Overview

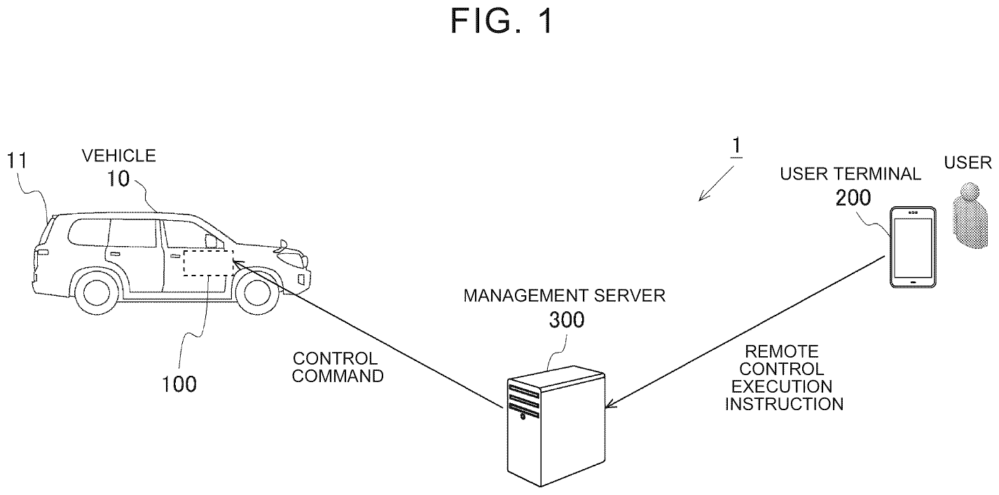

FIG. 1 is a diagram illustrating a flow of information in a remote control system according to the present embodiment. The remote control system 1 is a system for remotely controlling the vehicle 10. The remote control system 1 includes a control device 100, a user terminal 200, and a management server 300 mounted on the vehicle 10.

The control device 100 controls various devices mounted on the vehicle 10. The vehicle 10 is a vehicle that can be a target of remote control. The vehicle 10 includes a tailgate 11 that can be controlled to open and close by remote control. In the vehicle 10, the tailgate 11 is controlled by a control device 100. In addition, various sensors for detecting the state of the vehicle 10 are mounted on the vehicle 10. The detection values of the various sensors are input to the control device 100.

The user terminal 200 is a terminal related to a user of the vehicle 10. In the present embodiment, the user terminal 200 is carried by a user who is not in the vehicle 10. The user is, for example, an owner of the vehicle 10. The user may be a driver of the vehicle 10 who parks the vehicle 10 and gets off the vehicle 10. The management server 300 is a server device that remotely controls the vehicle 10. The management server 300 functions as an “external device” according to the present disclosure.

The control device 100, the user terminal 200, and the management server 300 are connected to each other via a network. Here, as the network, for example, a Wide Area Network (WAN) which is a public communication network such as the Internet or a telephone communication network such as a mobile telephone may be adopted. The network may also include telephone communication networks for cellular phones and the like, and wireless communication networks such as Wi-Fi (registered trademark).

When the user attempts to execute remote control of the vehicle 10, an instruction to execute remote control is transmitted from the user terminal 200 to the management server 300 based on an input from the user. Upon receiving an instruction to execute remote control from the user terminal 200, the management server 300 transmits a control command for remote control instructed to execute to the control device 100 of the vehicle 10. Upon receiving a control command from the management server 300, the control device 100 executes control of a device to be remotely controlled.

For example, when the control device 100 receives a control command for controlling the opening and closing of the tailgate 11 from the management server 300, the control device 100 executes the opening and closing control of the tailgate 11. However, when the received control command is the opening control command of the tailgate 11, the control device 100 first determines whether or not a predetermined condition is satisfied. Then, the control device 100 executes the opening control of the tailgate 11 when a predetermined condition is satisfied. Details of the opening control of the tailgate 11 by remote control will be described later.

### Hardware Configuration of the Control Device

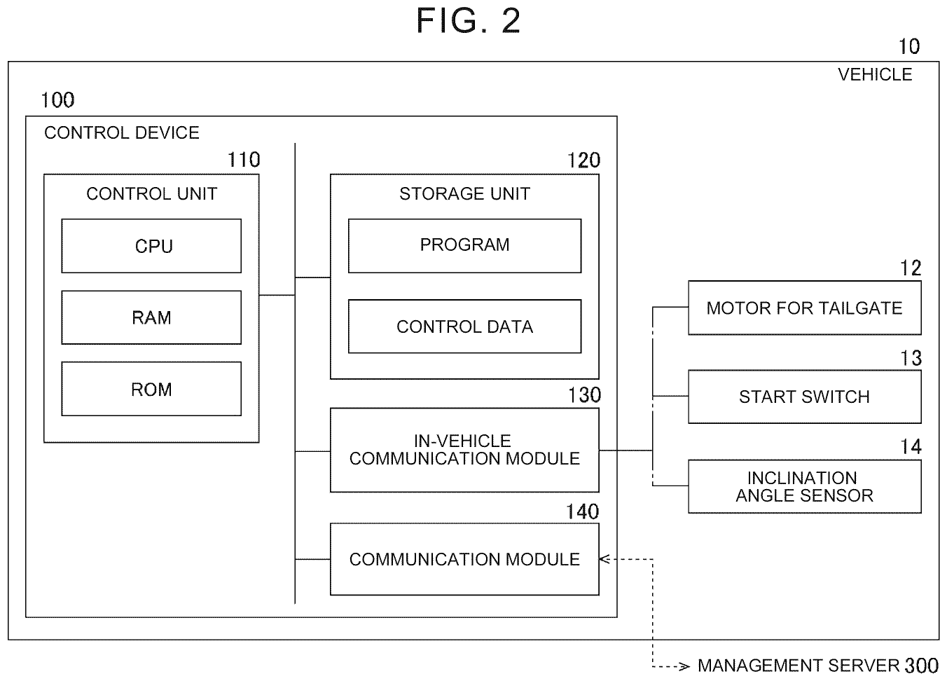

FIG. 2 is a block diagram for describing a hardware configuration of the control device 100 and various devices mounted on the vehicle 10 according to the embodiment. The control device 100 includes a control unit 110, a storage unit 120, an in-vehicle communication module 130, and a communication module 140. The control unit 110 has a function of performing arithmetic processing for controlling the control device 100. The control unit 110 includes a processor such as Central Processing Unit (CPU), a main storage device such as Random Access Memory (RAM), and a secondary storage device such as Read Only Memory (ROM). CPU is an exemplary processor resource. In addition, RAM and ROM are exemplary memory-resources. The control unit 110 can execute arbitrary information processing based on various programs and various data. However, some or all of the functions of the control unit 110 may be realized by a hardware-circuit such as a ASIC, FPGA.

The storage unit 120 is constituted by any storage device such as a RAM, ROM, a hard disk drive, or a flash memory. The storage unit 120 may include a removable medium (portable recording medium). Here, the removable medium is, for example, a USB memory, a SD card, or a disc recording medium such as a CD-ROM, DVD disc or a Blu-ray disc. The storage unit 120 stores programs to be executed by the control unit 110 and various types of data to be used for executing the programs. In addition, the storage unit 120 stores control data used to execute a program for remote control of the vehicle 10.

The in-vehicle communication module 130 is an interface for the control device 100 to communicate with other devices provided in the vehicle 10 using a predetermined in-vehicle communication standard. Examples of the predetermined in-vehicle communication standard include Controller Area Network (CAN) and Local Interconnect Network (LIN).

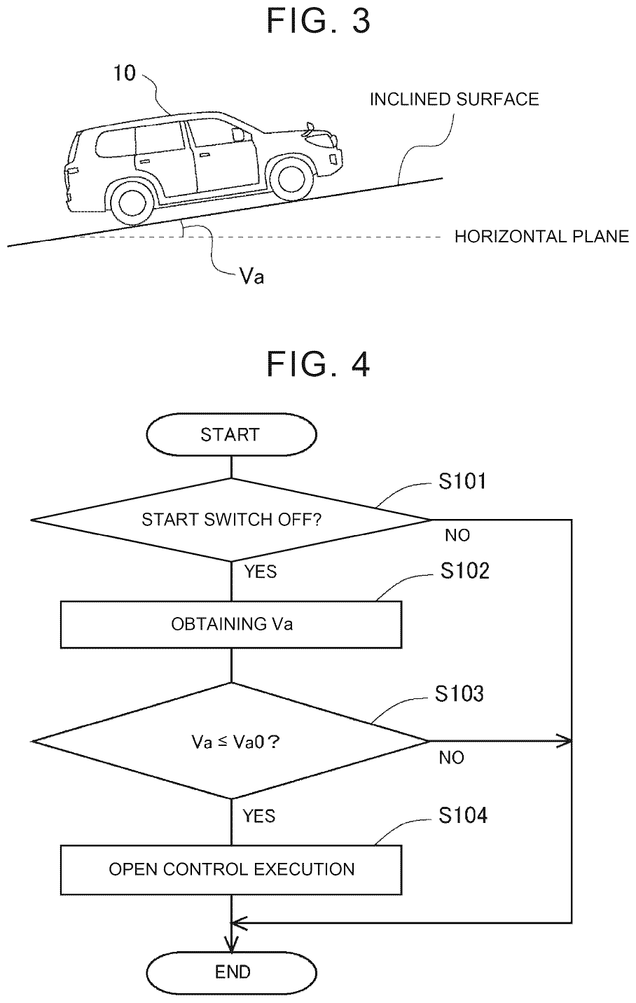

The vehicle 10 is provided with various devices such as a tailgate motor 12, a start switch 13, and an inclination angle sensor 14. The control device 100 communicates with the management server 300 via the in-vehicle communication module 130. The tailgate motor 12 is a motor for driving the tailgate 11 to open and close. The control device 100 controls the opening and closing of the tailgate 11 by driving the tailgate motor 12. The start switch 13 is a switch for driving a power source (for example, an internal combustion engine, a motor, or the like) of the vehicle 10. When the start switch 13 is turned ON, the control device 100 drives the power source of the vehicles 10. When the start switch 13 is turned OFF, the control device 100 stops driving the power source of the vehicles 10. The inclination angle sensor 14 is a sensor that detects an inclination angle in the front-rear direction with respect to the horizontal plane of the vehicle 10. FIG. 3 is a diagram illustrating a state of the vehicle 10 stopped on the inclined surface. As shown in FIG. 3, when the vehicle 10 is stopped on an inclined surface such as an uphill slope, the vehicle 10 is inclined in the front-rear direction. At this time, the inclination angle sensor 14 detects a front-rear inclination angle Va with respect to the horizontal plane of the vehicle 10. Then, the detection value of the inclination angle sensor 14 is input to the control device 100.

The communication module 140 is a communication interface for connecting the control device 100 to a network. The communication module 140 is, for example, a Local Area Network (LAN) interface board or wireless communication circuitry for wireless communication. The control device 100 communicates with the management server 300 via the communication module 140.

The management server 300 is also a computer including a control unit, a storage unit, and a communication module. In addition, the user terminal 200 has a processor such as a Central Processing Unit (CPU), a main storage device such as a Random Access Memory (RAM), a secondary storage device such as a Read Only Memory (ROM, and a communication interface for connecting the user terminal 200 to a network. Examples of the user terminal 200 include a smartphone, a tablet computer, a mobile computer, and a wearable computer.

Further, in the present embodiment, the control device 100 is not necessarily realized by a single physical configuration, and may be configured by a plurality of computers provided in the vehicle 10 and cooperating with each other.

### Flow of Information Processing

Next, a flow of information processing executed by the control device 100 will be described with reference to FIG. 4. Here, it is assumed that a user who is located at a place distant from the vehicle 10 uses the vehicle 10 as a place for receiving a courier. In this case, the user attempts to open the tailgate 11 of the vehicle 10 by remote control in order to have the delivery person receive the delivery item in the vehicle. At this time, the control device 100 executes the opening control of the tailgate 11 after confirming that a predetermined condition for securing safety is satisfied in the vehicle 10.

FIG. 4 is a flow of information processing related to opening control of the tailgate 11 by remote control according to the present embodiment. This flow is executed by the control unit 110 when the control device 100 receives an opening control command for the tailgate 11 from the management server 300.

In this process, first, in S101, it is determined whether or not the start switch 13 of the vehicle 10 is OFF. That is, in S101, it is determined whether or not the driving of the power source of the vehicles 10 is stopped. When a negative determination is made in S101, that is, when the power source of the vehicle 10 is driving, the execution of this process is temporarily ended. In this case, the tailgate 11 is not opened in the vehicle 10.

On the other hand, when an affirmative determination is made in S101, that is, when the driving of the power source of the vehicle 10 is stopped, S102 process is executed next. In S102, the front-rear inclination angle Va of the vehicle 10 detected by the inclination angle sensor 14 is acquired. Next, in S103, it is determined whether or not the inclination angle Va of the vehicles 10 acquired by S102 is equal to or less than a predetermined angle Va0. Here, the predetermined angle Va0 is set as an angle within a range in which movement of a package placed in the vehicle 10 due to inclination of the vehicle 10 is suppressed. When a negative determination is made in S103, that is, when the inclination angle Va of the vehicles 10 is larger than the predetermined angle Va0, the execution of this process is temporarily terminated. In this case, the tailgate 11 is not opened in the vehicle 10 as in the case where a negative determination is made in S101.

On the other hand, if an affirmative determination is made on S103, S104 process is executed next. In S104, the opening control of the tailgate 11 is executed. Specifically, the control unit 110 drives the tailgate motor 12 in the opening direction of the tailgate 11. After that, the execution of this flow is once terminated.

According to the above-described flow, it is possible to suppress the tailgate 11 from being opened by remote control when the vehicle 10 is moving. Further, it is also possible to suppress the tailgate 11 from being opened by remote control in a state in which the vehicle 10 is greatly inclined in the front-rear direction. As a result, it is possible to suppress the luggage placed inside the vehicle from falling outside the vehicle when the tailgate 11 is opened. Therefore, according to the present embodiment, it is possible to improve safety related to remote control of the tailgate 11 of the vehicle 10.

It is considered that a case where the vehicle 10 is inclined to the rear side as illustrated in FIG. 3 may occur that the luggage placed in the vehicle falls outside the vehicle when the tailgate 11 is opened. Therefore, in the present embodiment, the predetermined angle Va0 may be set to an angle at which the vehicles 10 incline rearward. According to this, even when the vehicle 10 is inclined, if the inclination direction is the front side of the vehicle 10, the opening control of the tailgate 11 is executed.

### Modified Examples

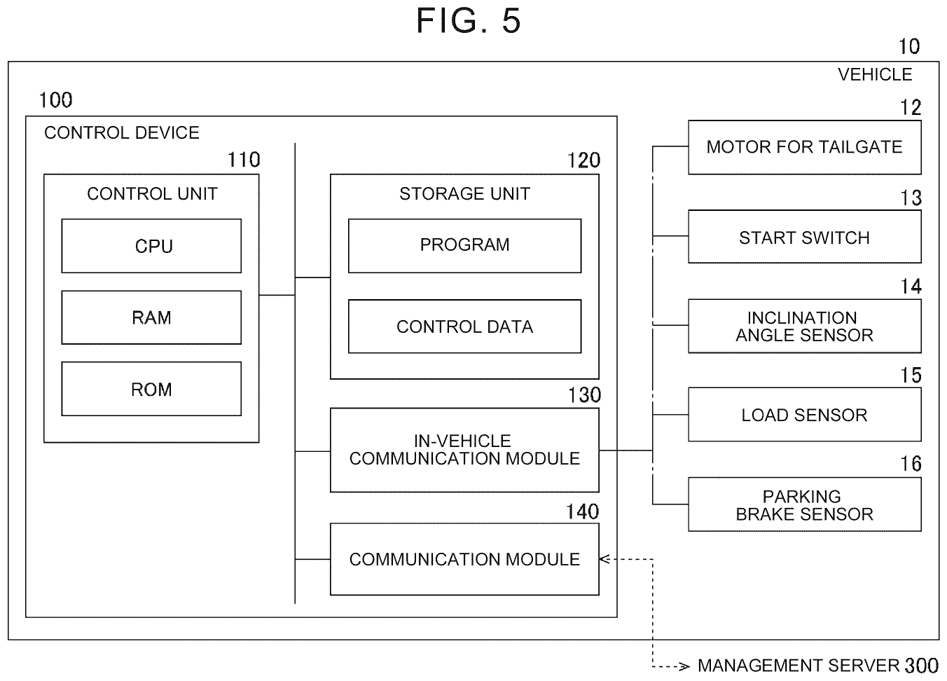

A modified example of the present embodiment will be described hereinbelow. In the present modification, a predetermined condition for executing the opening control of the tailgate 11 by remote control is different from the above-described embodiment. FIG. 5 is a block diagram for describing a hardware configuration of the control device 100 and various devices mounted on the vehicle 10 according to the present modification.

The configuration of the control device 100 according to the present modification is the same as that of the above-described embodiment. However, in the present modification, in the vehicle 10, the control device 100 communicates with the load sensor 15 and the parking brake sensor 16 via the in-vehicle communication module 130 in addition to the tailgate motor 12, the start switch 13, and the inclination angle sensor 14. The load sensor 15 is a sensor that detects a load applied to the tailgate motor 12. The parking brake sensor 16 is a sensor that detects whether or not a parking brake is applied to the vehicle 10. The detection values of these sensors are input to the control device 100.

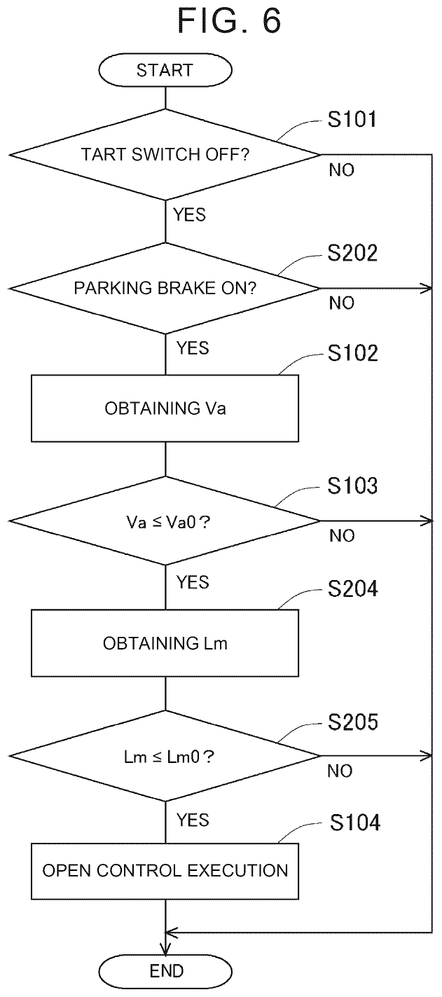

Next, a flow of information processing executed by the control device 100 according to the present modification will be described with reference to FIG. 6. FIG. 6 is a flow of information processing related to opening control of the tailgate 11 by remote control according to the present modification. This flow is also executed by the control unit 110 when the control device 100 receives an opening control command for the tailgate 11 from the management server 300, similarly to the flow illustrated in FIG. 4. Note that the processing from S101 to S104 in this flow is the same as the processing in the steps with the same reference numerals in the flow shown in FIG. 4. Therefore, the description of the processing in these steps will be omitted.

If an affirmative determination is made in S101, S202 process is executed next. In S202, whether or not the parking brake is applied in the vehicle 10 is determined based on the detected value inputted from the parking brake sensor 16. When a negative determination is made in S202, that is, when the parking brake is not applied in the vehicle 10, the execution of this process is temporarily terminated. In this case, the tailgate 11 is not opened in the vehicle 10. On the other hand, if an affirmative determination is made on S202, S102 process is executed next.

In this process, if an affirmative determination is made in S103, S204 process is executed next. In S204, it is determined whether or not the open-direction load Lm of the tailgate 11 applied to the tailgate motor 12, which is detected by the load sensor 15, is equal to or less than a predetermined load Lm0. Here, if a load is applied to the tailgate 11 from the inside by the load placed in the vehicle 10 contacting the tailgate 11, there is a possibility that the load falls out of the vehicle when the tailgate 11 is opened. Therefore, the predetermined load Lm0 is set as a threshold that can determine that a load is not applied to the tailgate 11 from the inside of the vehicle 10. When a load is applied to the tailgate 11 from the inside of the vehicle 10, a load Lm in the opening direction of the tailgate 11 applied to the tailgate motor 12 increases. Therefore, when the load Lm in the opening direction of the tailgate 11 applied to the tailgate motor 12 is equal to or less than the predetermined load Lm0, it can be determined that no load is applied to the tailgate 11 from the inside of the vehicle 10.

When a negative determination is made in S205, that is, when a load is applied to the tailgate 11 from the inside of the vehicle 10, the execution of this process is temporarily terminated. In this case, the tailgate 11 is not opened in the vehicle 10. On the other hand, when an affirmative determination is made in S202, that is, when no load is applied to the tailgate 11 from the inside of the vehicle 10, S104 process is executed next. That is, the opening control of the tailgate 11 is executed.

According to the above-described flow, it is possible to suppress the tailgate 11 from being opened by remote control in a state where the parking brake is not applied in the vehicle 10. Further, it is also possible to suppress the tailgate 11 from being opened by remote control in a state where a load is applied to the tailgate 11 from the inside by the load placed in the vehicle 10 contacting the tailgate 11. As a result, it is possible to suppress the load placed in the vehicle from falling out of the vehicle when the tailgate 11 is opened with a higher probability. Therefore, according to the present embodiment, it is possible to further improve safety related to remote control of the tailgate 11 of the vehicle 10.

### Other Embodiments

The above-described embodiments are merely examples, and the present disclosure may be appropriately modified and implemented without departing from the scope thereof. For example, the processes and means described in the present disclosure can be free combined and implemented as long as no technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc read-only memory (CD-ROM), digital versatile disc (DVD), Blu-ray disc, etc.), a read-only memory (ROM), a random access memory (RAM), an erasable programmable read-only memory (EPROM), an electrically erasable programmable read only memory (EEPROM), a magnetic card, a flash memory, or any type of medium suitable for storing electronic commands such as an optical card.

What is claimed is:

1. A control device that is installed in a vehicle equipped with a tailgate that is remotely controllable, the control device comprising a control unit for executing opening control of the tailgate, when a predetermined condition is satisfied when an opening control command of the tailgate is received from an external device, wherein the predetermined condition includes that driving of a motive power source of the vehicle is stopped, and also that an inclination angle in a front-rear direction with respect to a horizontal plane of the vehicle is no greater than a predetermined angle.

2. The control device according to claim 1, wherein the predetermined condition further includes that no load is being applied to the tailgate from inside of the vehicle.

3. The control device according to claim 2, wherein
the vehicle is equipped with a sensor for detecting a load applied to a motor for opening and closing driving of the tailgate, and
no load being is applied to the tailgate from inside of the vehicle is that a load applied to the motor in an opening direction of the tailgate, detected by the sensor, is no greater than a predetermined load.

4. The control device according to claim 1, wherein the predetermined condition further includes that a parking brake is applied in the vehicle.

5. A vehicle, comprising the control device according to claim 1.
